(19) United States
(12) Patent Application Publication
(10) Pub. No.: US 2008/0310657 A1
(43) Pub. Date: Dec. 18, 2008

(54) ELECTRET CONDENSER MICROPHONE

(75) Inventors: Yuki Tsuchiya, Minamitsuru-gun (JP); Kazuhiro Kobayashi, Fujiyoshida-shi (JP)

Correspondence Address: BRINKS HOFER GILSON & LIONE, P.O. BOX 10395, CHICAGO, IL, 60610, US

(73) Assignee: Citizen Electronics Co., Ltd.

(21) Appl. No.: 12/154,262

(22) Filed: May 21, 2008

(30) Foreign Application Priority Data
May 22, 2007 (JP) JP2007-135635

(51) Int. Cl. H04R 19/01; H04R 19/04

(52) U.S. Cl. 381/174

(57) ABSTRACT

An electret condenser microphone is provided that allows a reduction in the thickness of an electronic device to which it is installed. The electret condenser microphone has a circuit board (2), a spacer (8; 8 and 9) and a diaphragm (7), which are successively layered, and a cup-shaped shield casing (85) covering the layered members. A sound hole (10a) is provided to extend from the outer surface of the circuit board (2) through the spacer to communicate between a space formed between the diaphragm and an end wall of the shield casing and the outside of the electret condenser microphone.

### RELATED APPLICATIONS

This application claims priority under 35 U.S.C. §119 to Japanese Patent application No. JP2007-135635 filed on May 22, 2007, the entire contents of which are hereby incorporated by reference.

### TECHNICAL FIELD

The present invention relates to electret condenser microphones.

### BACKGROUND

In recent years, electret condenser microphones (hereinafter abbreviated as “ECMs”) have been widely used as small and high-performance microphones in electronic devices such as mobile phones, videocameras, and digital cameras. There has been a demand for reductions in the size and thickness of electronic devices. To meet the demand, ECMs to be installed in such electronic devices need to be smaller and thinner.

Japanese Patent Application Publication No. 2003-78997 discloses an ECM 80 as shown in FIG. 8. The ECM 80 has a circuit board 2, a first spacer 8, an electret substrate 3, a second spacer 9, and a diaphragm unit 6 with an electrically conductive support frame 6a, which are successively layered and housed in a metallic shield casing 85. The electret substrate 3 has an insulating substrate 3a with vent holes 3b and an electret layer 5 provided on the insulating substrate 3a with an electrode film 4 interposed therebetween. One side of the circuit board 2 is provided with output electrodes 2b to connect the ECM 80 to a main circuit board, i.e. a motherboard 100, of an electronic device. The other side of the circuit board 2 has electronic elements 11 and 12, such as an integrated circuit, provided thereover with respective connecting electrodes 2a interposed therebetween. The first spacer 8 is set to surround the electronic elements 11 and 12. The shield casing 85 is provided with a sound hole 10a at a position facing a diaphragm 7 of the diaphragm unit 6

In the ECM 80, the diaphragm 7 and the electret layer 5 form, in combination, a capacitor. When the diaphragm 7 is displaced by the air vibration of a sound input signal Ps input through the sound hole 10a, the capacitance of the capacitor changes, and the change in capacitance is taken out as an electric signal and led to the circuit board 2 through connecting conductors (not shown) that connect the diaphragm 7 and the electret layer 5 to the circuit board 2. After being processed in the integrated circuit, the signal is output from the output electrodes 2b to the motherboard 100 of an electronic device, e.g. a mobile phone, to which the ECM 80 is attached.

To install the ECM 80 in a mobile phone, for example, it needs to be mounted on the motherboard 100 in such a manner that the sound hole 10a is positioned close to a wall of a mobile phone casing (not shown) where a sound inlet opening is provided. Meanwhile, the surface of the casing wall that is provided with the sound inlet opening may be provided with numeric input keys, function keys, etc. to serve as a keypad. In such a case, it may be impossible to ensure a space corresponding to the thickness of the ECM 80 at the side of the motherboard 100 that faces the casing wall because this side of the motherboard 100 is provided with thin components such as sheet switches that are activated in response to an operation of the keypad on the outer surface of the casing. In this case, the ECM 80 has to be mounted on the side of the motherboard 100 that faces away from the casing wall. That is, in such a case, one side of the motherboard 100 is provided with the ECM 80, and the other side thereof is provided with thin components, e.g. sheet switches.

Japanese Patent Application Publication No. 2005-192180 discloses an ECM 90 as shown in FIG. 9. The ECM 90 differs from the ECM 80 shown in FIG. 8 in that a sound hole 2c is formed not in the shield casing 85 but in the center of the circuit board 2 and that, correspondingly, the constituent elements are layered in the following order and housed in the shield casing 85: the circuit board 2, the first spacer 8, the diaphragm unit 6, the second spacer 9, the electret substrate 3, and a third spacer 13.

The ECM 90, unlike the above-described ECM 80, can be mounted on a side of a motherboard 100 opposite to a side thereof that is provided with thin components necessary for a key operation, such as sheet switches. Consequently, the motherboard 100 can be set in close proximity to a casing wall of a mobile phone or other device that is provided with a sound inlet opening. That is, in this case, the ECM 90 need not be set in between the motherboard 100 and the casing wall. Therefore, the mobile phone or other device can be reduced in thickness as compared to the case of using the ECM 80.

In the case of the ECM 90, however, the wiring of connecting conductors (not shown) that connect the diaphragm 7 and the electret layer 5 to the circuit board 2 becomes complicated. That is, the diaphragm 7 has an electrically conductive film on the surface thereof, and the diaphragm support frame 6a is also electrically conductive. Therefore, the conductors that connect the electret layer 5 and the circuit board 2 have to be electrically isolated from the diaphragm 7 and the support frame 6a, which are located between the electret layer 5 and the circuit board 2. Thus, a complicated wiring operation is required, resulting in an increase in cost.

### BRIEF SUMMARY

Accordingly, an object of the present invention is to provide an electret condenser microphone improved from the viewpoint of reducing the thickness of electronic devices, such as mobile phones, in which the electret condenser microphone may be installed.

The present invention is applied to an electret condenser microphone including a circuit board (2) that has an outer surface, an inner surface and a peripheral edge surface between the outer surface and the inner surface, and that further has at least one electronic component (denoted by reference numerals 11 and 12 in the following embodiments) mounted on the inner surface. The electret condenser microphone further includes a spacer (8; 8 and 9) layered on the inner surface of the circuit board and the spacer is configured to surround the at least one electronic component, a diaphragm (7) layered on the spacer and having a first surface or a lower surface opposed to the inner surface of the circuit board and a second surface or an upper surface opposite to the first surface, and a casing (85) covering over the second surface of the diaphragm to form a space between an inner surface of the casing and the second surface of the diaphragm. An electret condenser microphone (10, 20 or 70) according to the present invention further includes a sound hole (10a) extending from the outer surface of the circuit board (2) through the spacer to communicate with the space formed between the second surface of the diaphragm and the inner surface of the casing and an space outside the electret condenser microphone.

Specifically, the casing (85) may be a cup-shaped casing that has an end wall (85a) with the inner surface opposed to the second surface of the diaphragm across a space and that further has a peripheral wall extending from the peripheral edge of the inner surface of the end wall to the peripheral edge of the circuit board.

As a more specific example, the electret condenser microphone may further include an electret substrate (3) that has an insulating substrate (3a) secured to the inner surface of the end wall and that further has an electrode (4) provided on the insulating substrate, and an electret layer (5) formed on the electrode and having a surface opposed to the second surface of the diaphragm.

As another specific example, the electret condenser microphone may further include an electrode (4) formed on the inner surface of the end wall, and an electret layer (5) formed on the electrode and having a surface opposed to the second surface of the diaphragm.

As still another specific example, the electret condenser microphone may be arranged as follows. The electret condenser microphone further includes an electret substrate (3) disposed between the diaphragm (7) and the circuit board (2). The spacer comprises a first spacer (8) and a second spacer (9). The circuit board (2), the first spacer (8), the electret substrate (3), the second spacer (9) and the diaphragm (7) are successively layered, and the sound hole extends through the circuit board, the first spacer, the electret substrate, the second spacer and the diaphragm.

Embodiments of the present invention will be explained below with reference to the accompanying drawings.

### BRIEF DESCRIPTION OF THE DRAWINGS

FIG. 1 is a sectional view of an electret condenser microphone according to a first embodiment of the present invention.

FIG. 2 is an exploded perspective view of various elements constituting the electret condenser microphone shown in FIG. 1.

FIG. 3 is a sectional view showing the way in which the electret condenser microphone shown in FIG. 1 is secured to a motherboard of an electronic device such as a mobile phone.

FIG. 4 is a perspective view of component assembly members used to produce a multiplicity of electret condenser microphones arranged as shown in FIG. 1, illustrating the component assembly members in the order in which they are layered.

FIG. 5 is a perspective view of a stack of the assembly members shown in FIG. 4.

FIG. 6a is a perspective view of a component assembly used for a single electret condenser microphone, which is formed by dividing the stack of the assembly members shown in FIG. 5.

FIG. 6b is a perspective view of an electret condenser microphone completed by housing the component assembly of FIG. 6a into a shield casing.

FIG. 7 is a sectional view of an electret condenser microphone according to a second embodiment of the present invention.

FIG. 8 is a sectional view of an electret condenser microphone according to a related conventional art.

FIG. 9 is a sectional view of an electret condenser microphone according to another related conventional art.

FIG. 10 is a sectional view of an electret condenser microphone according to a third embodiment of the present invention.

FIG. 11 is a sectional view showing the way in which the electret condenser microphone shown in FIG. 10 is secured to a motherboard of a mobile phone or the like.

### DETAILED DESCRIPTION OF THE PREFERRED EMBODIMENTS

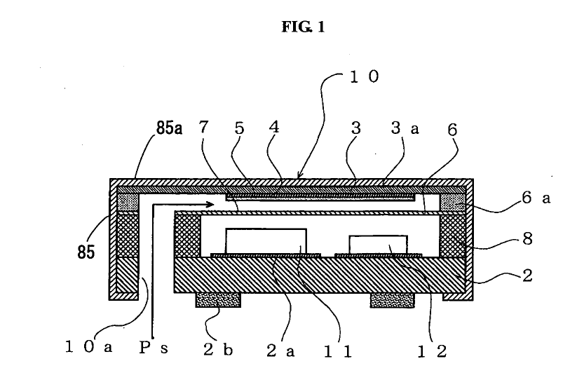

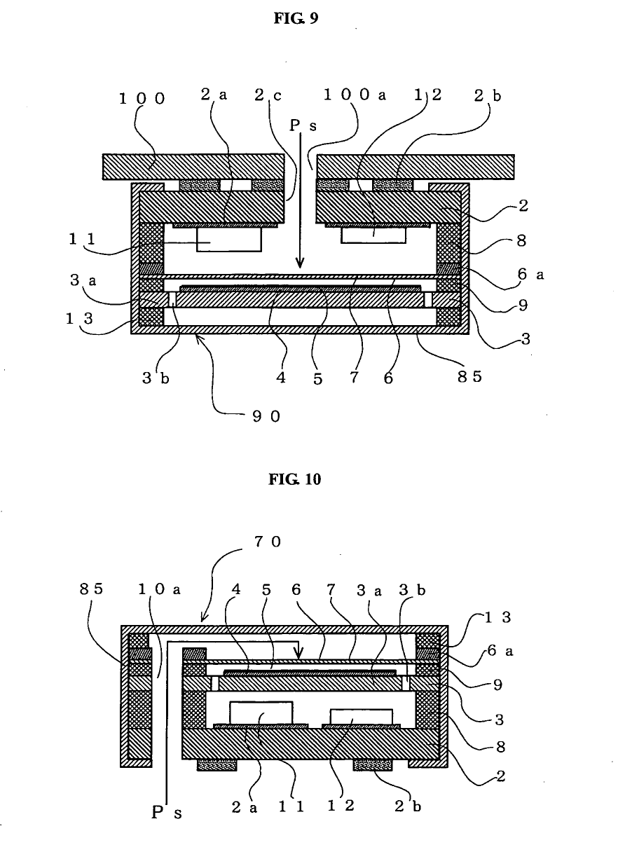

First, an electret condenser microphone (hereinafter abbreviated as “ECM”) according to a first embodiment of the present invention will be explained below with reference to FIGS. 1 to 6b. In these figures, the same constituent elements as those of the ECMs shown in FIGS. 8 and 9 are denoted by the same reference numerals as used in FIGS. 8 and 9.

The ECM 10 according to this embodiment has a circuit board 2, a spacer 8, a diaphragm unit 6 with an electrically conductive diaphragm support frame 6a, and an electret substrate 3, which are successively layered and housed in a metallic shield casing 85. The electret substrate 3 has an insulating substrate 3a and an electret layer 5 provided on the insulating substrate 3a with an electrode or electrode film 4 interposed therebetween. One side of the circuit board 2 is provided with output electrodes 2b to be connected to a motherboard 100 of an electronic device such as a mobile phone in which the ECM 10 is to be installed. The other side of the circuit board 2 has electronic elements 11 and 12, such as an integrated circuit, provided thereon with respective connecting electrodes 2a interposed therebetween. The spacer 8 is disposed on the circuit board 2 and configured to surround the electronic elements 11 and 12.

The diaphragm unit 6 includes an electrically conductive diaphragm 7 and a diaphragm support frame 6a secured to the peripheral edge of the diaphragm 7. The diaphragm support frame 6a includes an insulating member having a metal film provided on a surface thereof. Alternatively, the diaphragm support frame 6a is formed of a metal material. An insulating treatment is applied to the diaphragm unit 6 and the metallic shield casing 85 to prevent an electrical contact with each other.

In the ECM 10, a sound hole 10a disposed in the circuit board 2 extends through the circuit board 2, to communicate with a space between an upper surface of the diaphragm and an inner surface of the casing 85 and a space outside the casing of the ECM 10. Here, the spacer 8 and the diaphragm 7 have openings 8b and 7a respectively, and the openings 8b and 7a overlap with the sound hole 10a of the circuit board 2 in bottom plan view.

In comparison to the above-described ECMs 80 and 90, the ECM 10 does not need the spacers 9 and 13 and hence can be reduced in thickness. In addition, the electret substrate 3 is brought into close contact with an inner surface of an end wall 85a of the shield casing 85, and thus, even a thinned electret substrate 3 can be provided with rigidity. This configuration allows the insulating substrate 3a to be reduced in thickness, and hence enabling the ECM 10 to become thinner. Electrical connection between the electrode 4 on the electret substrate 3 and the circuit board 2 can be easily made through the metallic shield casing 85, for example, by a method wherein the electret substrate 3 is brought into close contact with the inner surface of the end wall 85a of the shield casing 85 and through-holes are provided in the insulating substrate 3a for electrical connection, while the cylindrical inner surface of the shield casing 85 is electrically connected to the circuit board. Further, an inner surface of the diaphragm 7 faces a wide gap for accommodating the electronic elements 11 and 12 provided on the circuit board 2, and the gap is made by the spacer 8 disposed on the circuit board 2 and the spacer 8 having an opening 8a to accommodate the electronic elements therein. Therefore, the diaphragm 7 is allowed to vibrate smoothly without the need to provide through-holes 3b as provided in the electret substrate 3 of the above-described conventional ECMs.

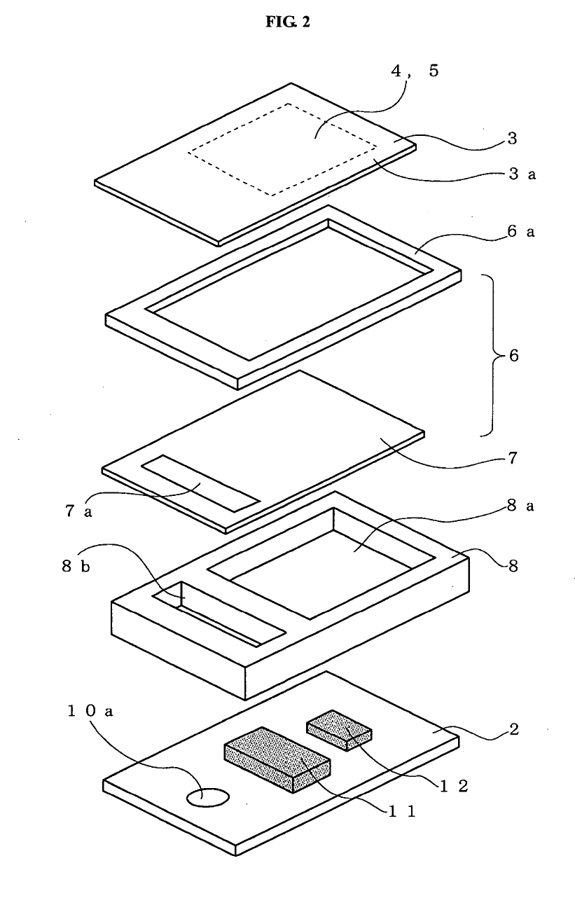

As shown in FIG. 2, the circuit board 2 is provided with a circular opening that forms a sound hole 10a. The spacer 8 is provided with an opening 8a for accommodating the electronic elements 11 and 12 of the circuit board 2 and an opening 8b that overlaps with the sound hole 10a. The diaphragm unit 6 is provided with an opening 7a that overlaps with the sound hole 10a.

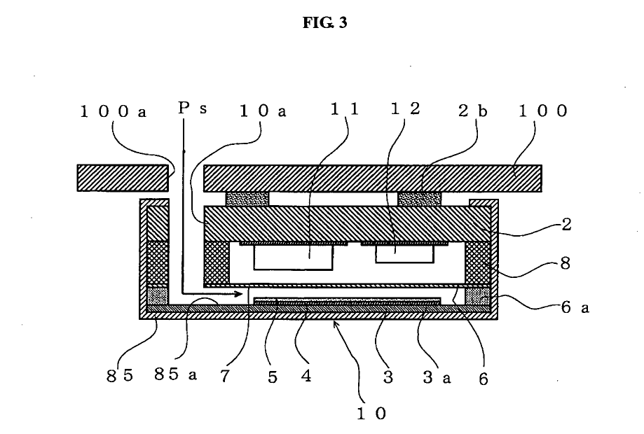

As shown in FIG. 3, the ECM 10 is secured to a main circuit board (motherboard) 100 by soldering the output electrodes 2b thereto in a state where the sound hole 10a is aligned with and adjacent to a sound hole 100a formed in the main circuit board 100.

In the ECM 10, a sound input signal Ps is input through the sound hole 100a of the main circuit board 100 and through the sound hole 10a of the ECM 10 and led into a gap between the diaphragm 7 and the electret layer 5 formed on the electret substrate 3. Consequently, the diaphragm 7 is vibrated by the sound input single Ps, causing a change in the capacitance provided between the electret substrate 3 and the diaphragm 7. The change in capacitance is taken out as an electric signal and led to the circuit board 2. After being processed in the integrated circuit 11, the signal is output from the output electrodes 2b of the circuit board 2.

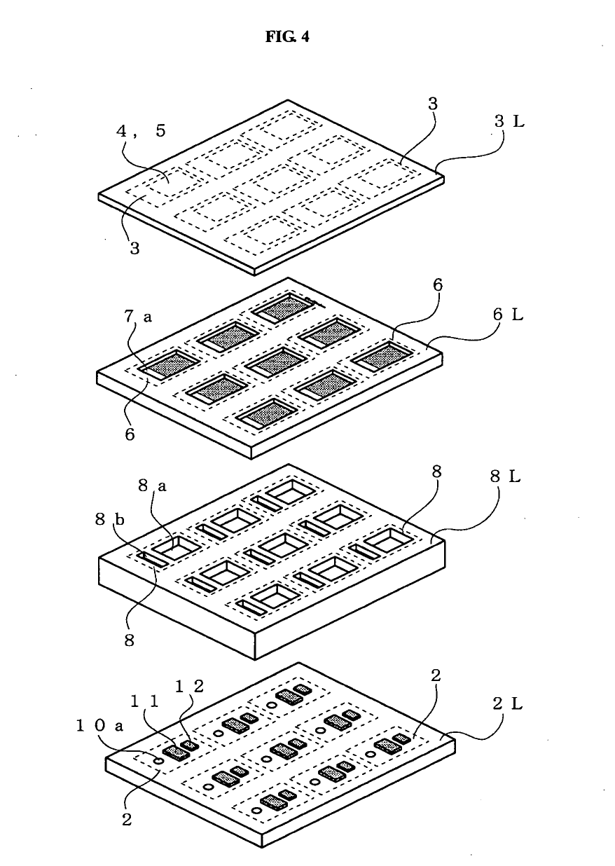

FIGS. 4 to 6b show a method of producing the ECM 10.

In FIG. 4, a circuit board assembly 2L has a multiplicity of circuit boards 2 arranged in a matrix in a plane and integrated together. Similarly, a spacer assembly 8L has a multiplicity of spacers 8 arranged in a matrix in a plane and integrated together. A diaphragm unit assembly 6L has a multiplicity of diaphragm units 6 arranged in a matrix in a plane and integrated together. An electret substrate assembly 3L has a multiplicity of electret substrates 3 arranged in a matrix in a plane and integrated together.

The assemblies 2L, 8L, 6L and 3L are layered and bonded to each other, as shown in FIG. 5, to form an ECM assembly 10L.

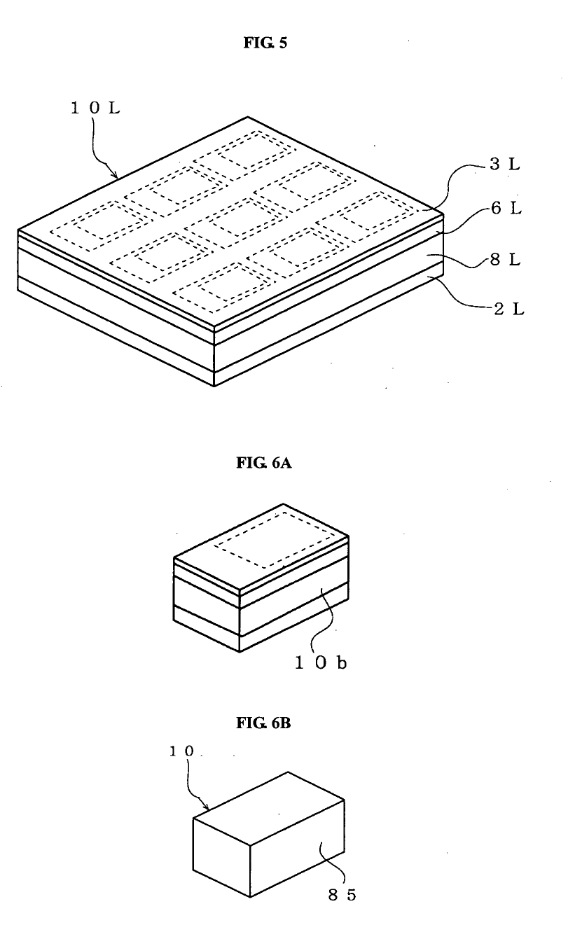

The ECM assembly 10L is divided by a cutting method, e.g. dicing, into individual ECM-components units 10b as shown in FIG. 6a. Each ECM-components unit 10b is housed in a shield casing 85, as shown in FIG. 6b, to complete an ECM 10.

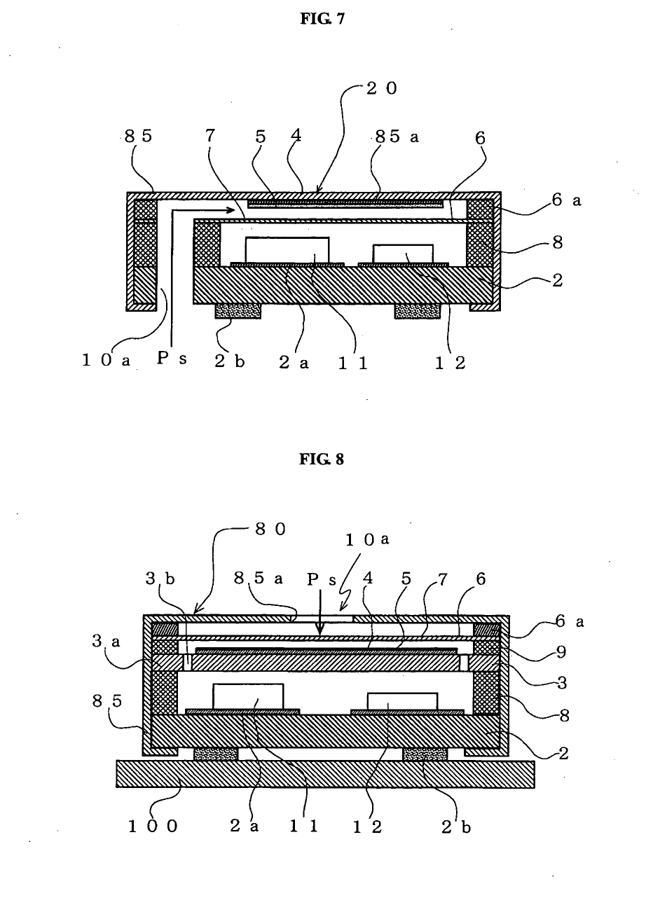

FIG. 7 shows an ECM 20 according to a second embodiment of the present invention. The ECM 20 is basically the same as the ECM 10. In the ECM 20, however, the insulating substrate 3a of the electret substrate is not used, but the electrode layer 4 and the electret layer 5 are formed directly on the inner surface of the end wall 85a of the shield casing 85. The ECM 20 can be made thinner than the ECM 10. Further, because the electrical connection between the electrode 4 and the circuit board 2 can be made directly through the shield casing 85, the ECM 20 dispenses with extra man-hours needed to form through-holes when the insulating substrate 3a is used.

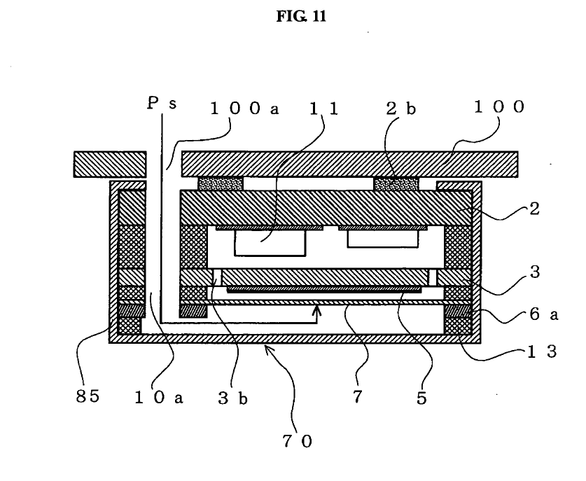

FIGS. 10 and 11 show an ECM 70 according to a third embodiment of the present invention.

The ECM 70 has a circuit board 2, a first spacer 8, an electret substrate 3, a second spacer 9, and a diaphragm unit 6, which are successively layered and housed in a metallic shield casing 85, in the same way as in the above-described conventional ECM 80. In the ECM 70, however, a sound hole 10a is provided in the circuit board 2 and communicate a space between the upper surface of the diaphragm 6 and the inner surface of the casing 85 in the same way as in the first and second embodiments. Further, a third spacer 13 is provided to allow the sound hole 10a to communicate with the space at the upper side of the diaphragm 7. Accordingly, the ECM 70 allows a reduction in thickness of an electronic device in which the ECM 70 is installed, as compared to the ECM 80. In addition, the ECM 70 facilitates electrical connection of the electret substrate 3 to the circuit board 2 and allows a reduction in the production cost, as compared to the conventional ECM 90.

Although in the above-described embodiments a rectangular diaphragm has been mainly shown, by way of example, the present invention is not necessarily limited thereto but may also be applied to a conventional circular or elliptic diaphragm. In the foregoing embodiments, the diaphragm support frame 6a also serves as a spacer for forming a gap between the upper surface of the diaphragm 7 and the electret layer 5 as a space for introducing the sound input signal Ps, the present invention is not necessarily limited to the described arrangement. A spacer may be provided on the diaphragm support frame 6a for the purpose of properly adjusting the gap between the upper surface of the diaphragm 7 and the electret layer 5. Although a single sound hole is provided in the circuit board 2 in the illustrated embodiments, a plurality of sound holes may be provided such that the sound holes extend through the peripheral portion of the diaphragm 7. Although the foregoing embodiments use a metallic shield casing configured to cover the whole ECM and having a shield function, the present invention is not necessarily limited thereto. Any shield casing may be used, provided that it has a function of forming a space at the upper side of the diaphragm unit. It is also possible to use a cup-shaped cover made of an insulating material in place of the metallic shield casing. The diaphragm is only required to be disposed and extend over a range in which it is vibrated, and it need not be disposed and extended over the entire width of the shield casing as in the illustrated embodiments. Therefore, the sound hole need not necessarily extend through the diaphragm as in the embodiments but may be positioned outside the diaphragm.

1. An electret condenser microphone comprising:
a circuit board having an outer surface and an inner surface, and a peripheral edge surface between the outer surface and the inner surface, and having at least one electronic component mounted on the inner surface;
a spacer layered on the inner surface of the circuit board and surrounding the at least one electronic component;
a diaphragm layered on the spacer and having a first surface opposed to the inner surface of the circuit board and a second surface opposite to the first surface; and
a casing covering over the second surface of the diaphragm to form a space between an inner surface of the casing and the second surface of the diaphragm;
the electret condenser microphone further comprising:
a sound hole extending from the outer surface of the circuit board through the spacer to communicate with the space formed between the second surface of the diaphragm and the inner surface of the casing and a space outside of the electret condenser microphone.

2. The electret condenser microphone of claim 1, in which the casing is a cup-shaped casing having an end wall and a peripheral wall extending from a peripheral edge of the inner surface of the end wall to the peripheral edge of the circuit board.

3. The electret condenser microphone of claim 2, further comprising:
an electret substrate having an insulating substrate secured to the inner surface of the end wall, an electrode provided on the insulating substrate, and an electret layer formed on the electrode and having a surface opposed to the second surface of the diaphragm.

4. The electret condenser microphone of claim 2, further comprising:
an electrode formed on the inner surface of the end wall; and
an electret layer formed on the electrode and having a surface opposed to the second surface of the diaphragm.

5. The electret condenser microphone of claim 2, further comprising:
an electret substrate disposed between the diaphragm and the circuit board;
the spacer comprising a first spacer and a second spacer;
the circuit board, the first spacer, the electret substrate, the second spacer and the diaphragm are successively layered, and the sound hole extends through the circuit board and communicates with a space through the first spacer, the electret substrate, the second spacer and the diaphragm.

6. The electret condenser microphone of claim 5, the electret substrate comprising:
an insulating substrate;
an electrode disposed on the insulating substrate; and
an electret layer formed on the electrode and having a surface opposed to the first surface of the diaphragm.

7. The electret condenser microphone of claim 1, in which the sound hole extends through the circuit board and communicates with the space through the spacer and the diaphragm.

8. The electret condenser microphone of claim 1, in which the sound hole extends from the outside surface of the circuit board to the space through the spacer and the diaphragm.
